(19) United States
(12) Patent Application Publication
(10) Pub. No.: US 2013/0255250 A1
(43) Pub. Date: Oct. 3, 2013

(54) TOLERANCE-CORRECTED ACTUATOR AND ASSOCIATED PRODUCTION METHOD

(71) Applicants: Dirk Naunheim, Stuttgart (DE); Jochen Schaeflein, Stuttgart (DE)

(72) Inventors: Dirk Naunheim, Stuttgart (DE); Jochen Schaeflein, Stuttgart (DE)

(73) Assignee: Bosch Mahle Turbo Systems GmbH & Co., KG, Stuttgart (DE)

(21) Appl. No.: 13/821,655

(22) PCT Filed: Aug. 29, 2011
(86) PCT No.: PCT/EP2011/064814

§ 371 Date: Jun. 19, 2013

(30) Foreign Application Priority Data
Sep. 10, 2010 (DE) 10 2010 040 583.3

(51) Int. Cl. F02M 25/07; F16C 7/02

(52) U.S. Cl. CPC F02M 25/077; F16C 7/02
USPC 60/602; 74/579 R; 29/890.12

(57) ABSTRACT

An approach for producing a tolerance-corrected actuator for a supercharging device may include connecting a connecting element to a regulating rod of a regulating component assembly, bringing a tolerance-corrected actuator into a predefined position in response to a defined signal and adjusting a predetermined overall length of the regulating component assembly by shifting the connecting element relative to the regulating rod.

### CROSS-REFERENCE TO RELATED APPLICATION

This application claims priority to German Patent Application DE 10 2010 040 583.3 filed Sep. 10, 2010, and International Patent Application PCT/EP2011/064814, filed Aug. 29, 2011, both of which are hereby incorporated by reference in their entirety.

### TECHNICAL FIELD

The present invention relates to a method for producing a tolerance-corrected actuator for a supercharging device, in particular for an exhaust-gas turbocharger of a motor vehicle. Furthermore, the invention likewise relates to a supercharging device, in particular an exhaust-gas turbocharger of a motor vehicle and an associated method for attaching an actuator to such a supercharging device.

### BACKGROUND

From DE 10 2008 045 227 A1 a method for the simplified attachment of an actuator designed as a pressure can to an exhaust-gas turbocharger is known. For offsetting tolerances on the part of the exhaust-gas turbocharger and on the part of the pressure can, an adjusting lever of a variable turbine geometry or of a wastegate valve is brought into a predefined position. This can, for example, be the position of the closed wastegate valve. Following this, the distance between a predefined attachment position of the pressure can and the adjusting lever is measured. Following this, the pressure can is likewise brought into a predefined position and the actuator rod of the actuator marked at one point. Here, the distance of this marked point to the attachment flange of the actuator on the exhaust-gas turbocharger corresponds to the length which was previously measured between the predefined attachment position of the actuator and the adjusting lever. Following this, the actuator is connected to the exhaust-gas turbocharger by means of the attachment flange and the actuator rod at the marked point connected to the adjusting lever. Through such an attachment method of an actuator to an exhaust-gas turbocharger, both the tolerances of the exhaust-gas turbocharger, in particular in the region of the wastegate valve or of the variable turbine geometry, as well as the tolerances of the actuator or of the pressure can, can be compensated.

Thus, through such a method, a tolerance offset of the assembly and production tolerances of an actuator and of a charging device can be carried out simultaneously. Usually, interface parts of the actuator and/or of the supercharging device are connected to one another during the assembly of the supercharging device in particular through welding-on.

Disadvantageous in such an assembly method of a supercharging device is the major effort involved during maintenance work if the actuator is to be exchanged. Here, the tolerances of the actuator can be so large that a simple replacement of the actuator is not possible, wherein a maintenance method that is similar to the assembly method of the supercharging device has to be carried out so that when replacing the actuator and the assembly and production tolerances of the new actuator and of the old supercharging device are taken into consideration. To the end customer or in a warranty case to a manufacturer of the supercharging device, this can involve high costs.

### SUMMARY

Accordingly, the present invention deals with the problem of stating an improved or at least an alternative embodiment for an actuator of a supercharging device, in particular of an exhaust-gas turbocharger in a motor vehicle, and for an associated production method and for a supercharging device, in particular for an exhaust-gas turbocharger of a motor vehicle and an associated attachment method of an actuator to such a supercharging device, which is characterized in particular through a simplified exchange of the actuator.

According to the invention, this problem is solved through the subjects of the independent claims. Advantageous embodiments are subject of the dependent claims.

With a method for producing a tolerance-corrected actuator for a supercharging device, in particular for an exhaust-gas turbocharger of a motor vehicle, wherein the actuator comprises a regulating component assembly, comprising a control rod and a connecting element that can be connected to the control rod, the invention is based on the general idea of bringing the actuator into a predefined position and to adjust a predetermined overall length of the control component by shifting the connecting element relative to the control rod and then connect the connecting element to the control rod. Through such a method, a predefined overall length of the regulating component assembly can be realised with respect to a predefined position of the actuator by shifting the connecting element relative to the control rod. Because of this, such a tolerance-corrected actuator can be advantageously produced. Since in this case with respect to a predefined position of the actuator the overall length of the regulating component assembly assumes a predefined length, the position tolerances of the actuator with such an actuator provided with a pre-adjusted length are compensated, which means that each actuator of the same type, which in a predefined position has a predetermined length, has negligible tolerances due to the position. Thus, when such an actuator is being exchanged, no tolerance correction has to be carried out. For example during maintenance, such a tolerance-corrected actuator can consequently be exchanged without elaborate tolerance correction. This reduces the cost to the end customer and if applicable in a warranty case also to the manufacturer of the supercharging device. Here, actuator of the same time is to mean actuators having the same specifications.

A further general idea of the invention is designing an actuator for a supercharging device, in particular for an exhaust-gas turbocharger of a motor vehicle in such a manner that the actuator comprises a regulating component assembly, by means of which at least translatory movements can be transmitted, wherein the overall length of the regulating component assembly in a predefined position of the actuator has a predetermined length.

A further general idea of the invention is a method for the attachment of an actuator to a supercharging device, in particular to an exhaust-gas turbocharger of a motor vehicle, wherein the actuator is positioned and fixed relative to the supercharging device, with which a variable turbine geometry or a wastegate valve of the supercharging device is brought into a predefined position, with which the actuator is brought into a predefined position, with which an adjusting lever rotation-movably connected to a regulating component assembly of the actuator is rotation-rigidly connected to an actuating element of the variable turbine geometry or of the wastegate valve. Since with such a method for the attachment of an actuator a tolerance-corrected actuator is being used, merely the assembly and production tolerances of the supercharging device have to be compensated upon the assembly of the actuator with the supercharging device during the attachment process.

Further important features and advantages of the invention are obtained from the subclaims, from the drawings and from the associated Figure description by means of the drawings.

It is to be understood that the features mentioned above and still to be explained in the following cannot only be used in the respective combination stated but also in other combinations or by themselves without leaving the scope of the present invention.

Preferred exemplary embodiments of the invention are shown in the drawings and are explained in more detail in the following description, wherein same reference characters relate to same or similar or functionally same components.

### BRIEF DESCRIPTION OF THE DRAWINGS

It shows, in each case schematically:

FIG. 1 a tolerance-correctable actuator,

FIG. 2 a tolerance-corrected actuator,

FIG. 3 the tolerance-corrected actuator, positioned and fixed to a supercharging device,

FIG. 4 an aligned wastegate valve brought into a predetermined position,

FIG. 5 the actuator positioned in a welding position in installation position with the supercharging device.

### DETAILED DESCRIPTION

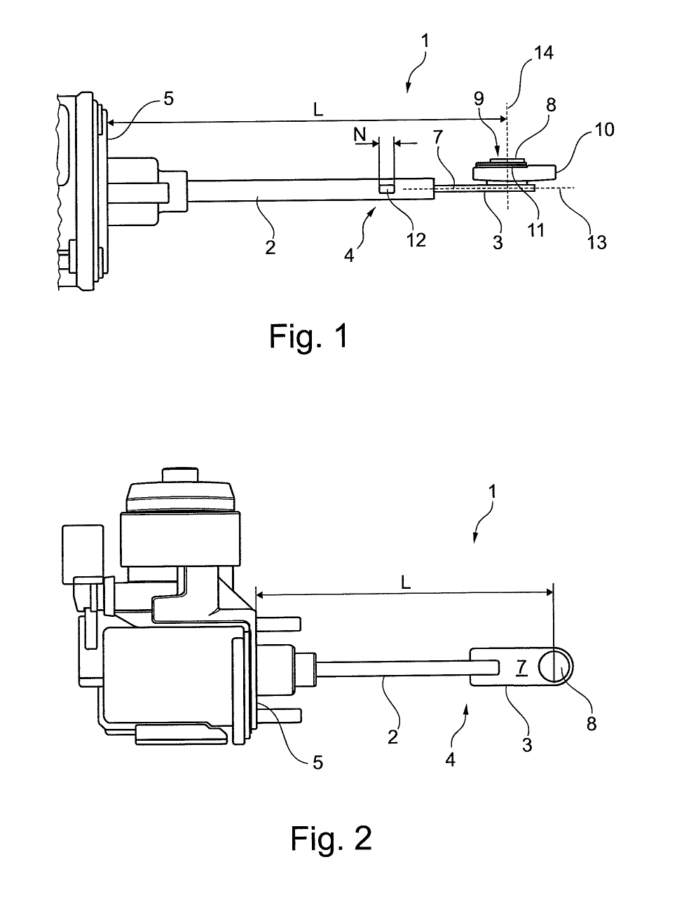

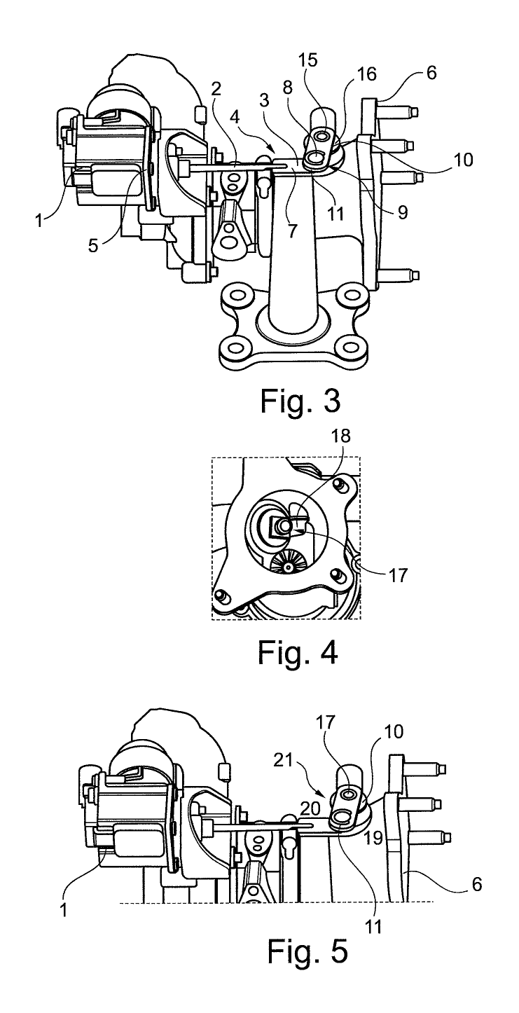

FIG. 1 shows an actuator 1 prior to the final assembly. The actuator 1 in this case comprises a regulating rod 2 and a connecting element 3. In the connected state, the regulating rod 2 and the connecting element 3 together form a regulating component assembly 4. Furthermore, the actuator 1 comprises a connecting flange 5, with which the actuator 1 can be connected to a supercharging device 6 shown in the FIG. 3. Here, the connecting element 3 is constructed of a connecting plate 7 and a connecting contour 8. The connecting contour 8 can be designed as pin or stud, which can be positioned in a recess 9 of an adjusting lever 10, and by means of a fixing element 11 can be fixed at least rotation-movably to the adjusting lever 10. Here, the fixing element 11 can be designed as locking rim, which following positioning of the connecting contour 8 in the recess 9 is pushed onto the latter.

Furthermore, the regulating rod 2 is equipped with a groove 12, into which the connecting plate 7 of the connecting element 3 can be pushed. By shifting the connecting plate 7 in the groove 12 along a longitudinal axis 13 of the regulating rod 2, an overall length L of the regulating component assembly 4 can be changed by the offsetting length N. Here, the overall length L can be determined as distance between the connecting flange 5 and a centre axis 14 of the connecting contour 8 designed as pin or stud. For forming a tolerance-corrected actuator 1, the overall length L is adjusted after the actuator 1 has been brought into a predefined position, by shifting the connecting plate 7 in the groove 12 along the longitudinal axis 13.

Here, a predefined position of the actuator 1 can be a defined position of the gearing and/or a defined position of the position sensor and/or a defined position of the regulating rod 2. Such a predefined position of the actuator 1 can be adjusted through a signal with which the actuator is supplied or can be detected by means of a signal for example of a sensor. Following the alignment of the connecting plate 7 in the groove 12, the regulating rod 2 is connected to the connecting plate 7 in the region of the groove 12. The connecting can be carried out through screwing, gluing, welding, riveting, crimping or the like. Following the final fixing of the connecting plate 7 to the regulating rod 2, such a tolerance-corrected actuator 1 has a predetermined overall length L with respect to a predefined position of the actuator. A completed, tolerance-corrected actuator 1 is shown in FIG. 2.

FIG. 3 shows the actuator 1 in installation position with the supercharging device 6. Here, the actuator 1 is tolerance-corrected according to the method described before and connected to the adjusting lever 10, for example as described before. Here, the adjusting lever 10 is connected to the regulating component assembly 4 rotation-movably relative to the connecting contour 8. A further recess 15 of the adjusting lever 10 is positioned above an opening 16 of the supercharging device 6, wherein the opening 16 is designed for receiving an actuating element 17.

According to FIG. 4, such an actuating element 17 can be designed as spindle or stud, which for example in the case of a wastegate valve, is rotation-rigidly connected to a flap 18 of the wastegate valve. For aligning, the actuating element 17 is now pushed into the opening 16 and the flap 18 of the wastegate valve brought into a predefined position. Here, the predefined position can be the position of the closed wastegate valve.

As is shown in FIG. 5, the actuating element 17 is then arranged in the further recess 15 of the adjusting lever 10. Following positioning of the actuating element 17 in the further recess 15, the tolerance-corrected actuator 1 is brought into a centre position 19 and slowly moved into a connecting position 20 in order to take play out of the system. Here, during this movement of the actuator 1, the variable turbine geometry or the wastegate valve is fixed in the respective predefined position. On reaching the connecting position 20, the actuating element 17 is connected to the adjusting lever 10 at the connecting point 21. Preferably, the connecting point 21 is designed as welding point.

Accordingly, the production or assembly tolerances of the actuator 1 and of the supercharging device 6 are compensated insofar that they are negligible. Since the actuator 1 is now connected to the adjusting lever 10 via the connecting contour 8 of the connecting element 3 by means of a fixing element 11, the actuator 1 can be separated from the adjusting lever 10 by disconnecting the fixing element 11. Following the disconnection of the connecting flange 5, the actuator 1 can be completely separated from the supercharging device 6. Since the actuator 1 is embodied in a tolerance-corrected manner, it can thus be quickly exchanged and following connecting of the new exchanged actuator 1 by means of the fixing element 11 to the adjusting lever 10, the function of the supercharging device 6 in interaction with the actuator 1 is re-established as before.

Preferably, an electric actuator is used as actuator 1 and particularly preferably an electric wastegate adjustor.

Following the completed assembly of the actuator 1 to the supercharging device 6 and after the connecting of the connecting element 17 to the adjusting lever 10 and, both the adjusting valve of the actuator with a closed wastegate valve or a closed variable turbine geometry as well as the concentricity of the regulating rod can be measured. Here, the measuring can take place on a coordinate measuring machine.

In the case of the welding of the actuating element 17 to the adjusting lever 10, the welding point can be preheated to 500+/−100° C. by means of a laser and then the welding of the actuating element 17 to the adjusting lever 10 carried out by means of a solid state laser.

1. A method for producing a tolerance-corrected actuator for a supercharging device comprising: connecting a connecting element to a regulating rod of a regulating component assembly,
bringing a tolerance-corrected actuator into a predefined position in response to a defined signal,
adjusting a predetermined overall length of the regulating component assembly by shifting the connecting element relative to the regulating rod and
wherein the connecting element is connected to the regulating rod in a fixed manner.

2. The method according to claim 1, further comprising pushing a connecting plate into a groove of the regulating rod for adjusting the overall length of the connecting element.

3. An actuator on a supercharging device, comprising: a regulating component assembly configured to transmit at least translatory movements, wherein a length of the regulating component assembly at a predefined position of the actuator has a predetermined overall length, wherein the actuator with respect to the overall length is tolerance-corrected and two actuators of the same type have the same overall length.

4. The actuator according to claim 3, wherein the regulating component assembly includes a regulating rod and a connecting element connected to the regulating rod.

5. The actuator according to claim 4, wherein the connecting element includes a connecting plate and a connecting contour.

6. The actuator according to claim 5, wherein the connecting plate is at least partially pushed into a groove of the regulating rod.

7. The actuator according to claim 5, wherein the overall length of the regulating component assembly is defined as a distance from the connecting contour to a connecting flange of the actuator, wherein the actuator is connected to the supercharging device via the connecting flange.

8. The actuator according to claim 5, wherein the connecting contour is designed as at least one of a pin and a stud, and is at least rotation-movably positioned in a recess of an adjusting lever of at least one of a variable turbine geometry and of a wastegate valve by a fixing element.

9. A method for attaching an actuator to a supercharging device, comprising:
positioning the actuator relative to the supercharging device,
bringing at least one of a variable turbine geometry and a wastegate valve of the supercharging device into a predefined position,
bringing the actuator into a predefined position,
connecting an adjusting lever to a regulating component assembly of the actuator; and
connecting an actuating element of the at least one of the variable turbine geometry and the wastegate valve to the adjustment lever.

10. The method according to claim 9, further comprising introducing the actuating element designed as at least one of a spindle and stud into a further recess of the adjusting lever.

11. (canceled)

12. The actuator according to claim 6, wherein the overall length of the regulating component assembly is defined as a distance from the connecting contour to a connecting flange of the actuator, wherein the actuator is connected to the supercharging device via the connecting flange.

13. The actuator according to claim 12, wherein the connecting contour is designed as at least one of a pin and stud and is at least rotationally and movably positioned in a recess of an adjusting lever of at least one of a variable turbine geometry and of a wastegate valve by a fixing element.

14. The actuator according to claim 6, wherein the connecting contour is designed as at least one of a pin and a stud and is at least rotationally and movably positioned in a recess of an adjusting lever of at least one of a variable turbine geometry and of a wastegate valve by a fixing element.
